(19) United States
(12) Patent Application Publication
(10) Pub. No.: US 2004/0214615 A1
(43) Pub. Date: Oct. 28, 2004

(54) User interface and communications system for a motor vehicle and associated operating methods

(76) Inventors: Volker Entenmann, Affalterbach (DE); Markus Hess, Baltmannsweiler (DE); Siegfried Rothe, Denkendorf (DE)

Correspondence Address: KENYON & KENYON, ONE BROADWAY, NEW YORK, NY, 10004, US

(21) Appl. No.: 10/813,936

(22) Filed: Mar. 30, 2004

(30) Foreign Application Priority Data
Apr. 9, 2003 (DE) 103 16 477.4

(51) Int. Cl. H04Q 7/20

(52) U.S. Cl. 455/569.2; 455/575.9; 455/90.3

(57) ABSTRACT

A user interface for a communications system in a motor vehicle, in a restrictive operating mode, restricts a functionality of a radio interface for wire-free connection to a radio communications network. A communications system for a motor vehicle includes a radio interface for wire-free connection to a radio communications network and for setting up a corresponding communications link. In the restrictive operating mode, the user interface displays the operating mode with restricted functionality to the caller and makes a plurality of communications functions available to him in a selectable fashion, the user interface activating the selected communications function. The communications system includes a device for detecting first and/or second traffic situations and for defining a radio communication as incapable of being carried out if one of the first traffic situations is detected, and as capable of being carried out if one of the second traffic situations is detected.

### CROSS-REFERENCE TO RELATED APPLICATIONS

The present application claims priority to Application No. 103 16 477.4, filed in the Federal Republic of Germany on Apr. 9, 2003, which is expressly incorporated herein in its entirety by reference thereto.

### FIELD OF THE INVENTION

The present invention relates to a user interface for a communications system in a motor vehicle, to a communications system for a motor vehicle according, and to associated operating methods.

### BACKGROUND INFORMATION

Telephone calls while driving constitute a problem in terms of driving safety and traffic safety. As a result it may be necessary to ensure that operating the telephone and conducting a telephone call does not cause a driver to be distracted from his primary driving function and from observing the traffic environment.

Hands-free devices in vehicles are a conventional and often even prescribed measure for counteracting these operating problems. For example, in certain contemporary vehicle models there are steering wheel keys which permit the driver to receive or end telephone calls while driving without having to take his hands off the steering wheel. However, driving situations may occur in which it is difficult to operate the steering wheel keys, for example on tight bends.

Moreover, in addition to operating the phone, the cognitive processes which are required of the driver by the telephone call contribute significantly to distracting him. Despite the fact that he is concentrating on the telephone call, the driver must not neglect to observe the other road users. Moreover, the driver generally feels obliged to accept an incoming telephone call even if he is actually not at all in a position to do so due to the driving situation at that particular time.

A further problem is abrupt interruptions of an existing communications link, for example when traveling into a tunnel or when the driver reaches an area which is not covered by the mobile radio network. On the one hand, such sudden interruptions may adversely affect his convenience, but on the other hand they also lead to new operating maneuvers which the driver has to carry out in order to restore the telephone link which has just been interrupted.

International Published Patent Application No. WO 03/001832 describes a user interface and a communications system for a motor vehicle with a radio interface for wire-free connection to a radio communications network and for setting up a corresponding communications link, it being possible to restrict a functionality of the radio interface. The restriction of the radio interface consists in the fact that incoming telephone calls are diverted, as a function of predefinable conditions, into a mailbox which the driver can listen to at a later time. Such conditions are, for example, traveling through sensitive localities or a vehicle speed which is within predefined speed ranges. The information about the sensitive localities is supplied by a navigation system.

A frequent argument from the point of view of the customer against suppressing or passing on telephone calls is that it may be a very important call which the customer would not wish to miss under any circumstances because it could have serious consequences of a personal, professional or financial nature. In conventional solutions, the vehicle system alone decides whether a call is suppressed or passed on without knowing anything about the urgency or importance of the call.

It is an aspect of the present invention to make available an improved user interface and an improved communications system for a motor vehicle, and associated communications methods in which telephone communications are handled in a manner which is adapted to a situation, and as a result the driver may very reliably be prevented from being distracted from the actual driving function. In addition, it is an aspect of the present invention to improve the convenience by virtue of the feature that unavoidable interruptions of the communications link may be detected early and measures permitting a call to be conducted in a targeted fashion may be taken.

The above and other beneficial aspects of the present invention may be achieved by providing a user interface for a communications system in a motor vehicle having the features described herein, and by providing a communications system for a motor vehicle having the features described herein, and by providing operating methods having the features described herein.

### SUMMARY

As aspect of the present invention may enable the caller himself to decide about the urgency of his call. In the case of less important calls, the caller may be able to consider whether to interrupt the call and call back later if the called party may not immediately accept the call. On the other hand, in the case of urgent and important calls, the caller may be prepared to wait for a certain additional time until the call is put through. In such a case, the caller may himself not be in a situation which requires action under time pressure, or stresses him greatly.

In respect of the above, an example embodiment of the present invention may provide a user interface which, in a restrictive operating mode, may restrict a functionality of a communications system in a motor vehicle, and, in the operating mode with restricted functionality, makes available to a caller a plurality of communications functions from which he may select at least one. In this restrictive operating mode, a call signal of an incoming call may be suppressed, and as a result the driver or the user may not accept the telephone call himself.

In an exemplary embodiment of the present invention, the restrictive operating mode of the user interface is activated by the user or driver by a corresponding input. If, for example, the driver feels greatly stressed in a traffic situation and would like to accept incoming telephone calls now but not conduct the telephone call until later, i.e., after the end of the traffic situation, by activating the restrictive operating mode he may signal to the caller that he will accept the call shortly. The user input may be made, for example, using manual activation device in the form of an additional key next to the transmitter key and the call-ending key or using a “soft key.” In addition, or as an alternative, the user input may also be made using a voice-control system.

If the restrictive operating mode is activated, the driver may conduct the call after the stress from the traffic situation has abated, provided that the caller has waited.

As a result, a user interface for a corresponding communications system is made available which communicates with the caller on the part of the driver so that the driver may not be distracted by the incoming call in a difficult traffic situation.

The user interface makes available to the caller, as has already been stated above, a plurality of communications functions from which the caller may select a communications function. As a result, the communications link is cut when a first communications function is selected, and in the case of a second communications function the caller is connected to a mailbox. In the case of a third communications function the call signal is activated, and in the case of a fourth communications function the communications link is maintained and the call signal is activated after a predefined time period has expired.

The communications functions are selected, for example, by activating a predefined numerical key on the telephone of the caller which is assigned to the corresponding communications function. The selectable communications functions may be displayed to the caller, for example, by a speech output and/or by a written output on a display unit of his telephone.

In accordance with an example embodiment of the present invention, a communications system for a motor vehicle may include a device for detecting traffic situations which evaluates data in order to detect first and/or second traffic situations, a radio communication being defined as incapable of being carried out if the first traffic situations are detected, and a radio communication being defined as capable of being carried out if the second traffic situations are detected.

In an example embodiment of the communications system, the device for detecting traffic situations evaluates, as a function of a predefinable route, for example, data from a navigation system and/or from a locating system and/or from trial sample vehicles and/or from a digital road map, in order to detect first sections of a route with the first traffic situations and/or second sections of a route with the second traffic situations. Trial sample vehicles are vehicles which are involved in the road traffic and pick up what is referred to as FCD (Floating Car Data) or XFCD (Extended Floating Car Data) and transmit it via a control center or directly to the communications system in the vehicle, the data including, for example, speed data, weather data, road status data, etc. Data from the data sources which are mentioned for example may be used to detect potentially difficult sections of a route such as, for example, bends, entries and exits, intersections, tunnels, etc., on which the first traffic situations, in which it may not be possible to carry out a telephone communication, frequently occur. In addition, second sections of a route may be detected on which first traffic situations do not occur and which are long enough in order to carry out a radio communication. This occurs, for example, on relatively long sections of motorway and on parts of routes on well constructed roads outside enclosed localities.

In an example embodiment of the communications system according to the present invention, the device for detecting traffic situations evaluates data from at least one traffic assistance system and/or from at least one vehicle sensor in order to determine whether a current vehicle situation corresponds to one of the first or one of the second traffic situations.

As a result, for example, the data from an anti-lock brake system and/or a ranging warning system and/or a traction control system and/or a parking aid system and/or a lane detection system and/or a system for warning against falling asleep at the wheel and/or a lane changing assistance system and/or a stop & go assistance system and/or a night view system and/or a road sign detection system and/or a pedestrian detection system, etc., may be evaluated. By evaluating this data it is possible, for example, to detect driving maneuvers which correspond to a first traffic situation, such as braking phases and acceleration phases, severe steering maneuvers, driving up to a vehicle which is traveling ahead, etc.

In an example embodiment of the communications system, the device for detecting traffic situations also determines an anticipated time period for the detected traffic situation. In order to be able to determine a reliable value for the time period, it is possible, for example, to evaluate the speed profile of the vehicle using its current movement state, and the properties of the section of route ahead, such as bends, speed limits, etc.

In an example embodiment of the present invention, the communications system includes not only the device for detecting traffic situations but also the user interface which is described above and whose restrictive operating mode is activated by the communications system when one of the first traffic situations is present. The preparedness to wait may depend essentially on the waiting period and on the cause for the delay. As a result of the combination of the user interface with the device for detecting traffic situations it is possible for the cause and the anticipated time period for the operating mode with restricted functionality to be displayed to the caller since the time period corresponds to the time period for a currently occurring, first traffic situation. As a result, the caller may decide whether he wishes to wait to put through the call or wishes to select another communications function which is provided by the user interface. It is then possible to inform the caller, for example, that the driver is currently in a difficult traffic situation and may accept the call in, e.g., approximately 20 seconds.

In an example embodiment of the communications system according to the present invention, the communications system informs the driver of an unavoidable interruption in an existing communications link at an early time, for example, before traveling into a tunnel or into an area which is not covered by a mobile radio network. If the vehicle approaches, for example, a tunnel, the driver may be informed, by a corresponding display or an audible signal, that it is highly probable that it will not be possible to continue the telephone call in the tunnel. In addition, the driver is informed when he will reach the tunnel (for example in 20 seconds) and for how long it is anticipated he will be located in the tunnel. This permits the driver and the called party to end the call in an orderly manner or to agree to resume the call after the interruption of the link. In addition, the communications system stores information relating to the existing communications link and provides this information to the driver automatically again after the tunnel, the driver being able to restore the previously ended communications link, for example, by pressing a key. As a result, the number of operator control actions which are necessary for the driver may be minimized. The information about sections of the route and areas in which mobile communication is not possible may be stored on a digital road map.

An example embodiment of the communications system according to the present invention includes an operator interface with which telecommunications which are desired by the driver or user may be managed in a manner which is adapted to the situation. In particular when travelling in an unknown area it may be difficult for the driver to detect the sections of a route which are optimum for a telephone call to be conducted. Two requirements may be made of these sections of a route. They may on the one hand contain no difficult driving situations, i.e., first traffic situations such as, for example, tight bends, entries and exits, intersections, etc., and they may be long enough for radio communication. In the case of journeys in an unknown area, the driver may use a navigation system so that it may be possible to determine, for the route which is calculated by the navigation system, the second sections of the route which are most suitable for telephone communication, for example, relatively long sections of a motorway or parts of a route on well constructed roads outside localities. Before starting his journey, the driver may use the operator interface to input whom he would like to call during the journey and how long the individual calls will approximately last. The communications system then assigns the at least one communications link which has been input by the driver to at least one of the second sections of a route—determined by the device for detecting traffic situations—which is most suitable for carrying out the telephone communication. This assignment and the anticipated optimum time for the communications link are then output to the driver as a communications proposal. If the driver accepts the communications proposal, he may then be informed when the associated second section of a route is reached. In addition, or as an alternative, the communications link which has been input may be released when the associated section of a route is reached.

The foregoing may prevent the driver from being distracted from the actual driving function in difficult driving situations by incoming and outgoing telephone calls, resulting in dangerous situations. The foregoing therefore may provide a significant contribution to improving driving safety and traffic safety. An aspect in comparison with other approaches to a solution is that when incoming calls are received, the caller himself is placed in a position to decide about the urgency of his call. This may ensure that really important calls are not simply lost. This may be important for reasons of acceptance. On the other hand, the foregoing intentionally dispenses with interrupting, at the system, calls which have already been started, which the user perceives as decreasing his convenience. If, however, an interruption of the call is unavoidable due to external factors, the driver is then informed at an early time about this, which may avoid an unexpected interruption of the call and may increase the convenience. At the same time, the number of operator control actions for the resumption of the call may be reduced, which also may reduce the distracting effect of the telephone.

In accordance with an example embodiment of the present invention, a user interface for a communications system in a motor vehicle includes: an arrangement configured to restrict, in a restrictive operating mode, a functionality of a radio interface to a wireless communication to a radio communications network; an arrangement configured to display, when there is a call in the restrictive operating mode, the restrictive operating mode to a caller and to make available a plurality of communications functions, at least one communications function selectable by the caller; and an arrangement configured to activate a selected communications function.

The user interface may include an arrangement configured to activate the restrictive operating mode in accordance with a user input and an activation instruction issued by a vehicle-mounted device.

The user interface may include at least one of (a) a manual activation device and (b) a voice-control system, the at least one of (a) the manual activation device and (b) the voice-control system configured to receive the user input.

The user interface may be configured to suppress a call signal in the restrictive operating mode.

One of the communications functions may include cutting a communications link. One of the communications functions may include connecting the caller to a mailbox. One of the communications functions may include activating a call signal. One of the communications functions may include maintaining a communications link and activating a call signal after a determinable time period has expired.

A first one of the communications functions may include cutting a communications link, a second one of the communications functions may include connecting the caller to a mailbox, a third one of the communications functions may include activating a call signal, and a fourth one of the communications functions may include maintaining a communications link and activating a call signal after a determinable time period has expired.

In accordance with an example embodiment of the present invention, a communications system for a motor vehicle includes: a radio interface configured to wirelessly connect to a radio communications network and to establish a corresponding communications link; and an arrangement configured to detect at least one of (a) a first traffic situation and (b) a second traffic situation, to define a radio communication as incapable of being performed in accordance with a detection of the first traffic situation, and to define the radio communication as capable of being performed in accordance with a detection of the second traffic situation.

The arrangement may be configured to evaluate, as a function of a predefinable route, data from at least one of (a) a navigation system, (b) a locating system, (c) at least one trial sample vehicle, and (d) a digital road map to determine at least one of (a) first sections of a route with first traffic situations and (b) second sections of a route with second traffic situations.

The arrangement may be configured to evaluate a current traffic situation as a function of date from at least one of (a) at least one driver assistance system and (b) at least one vehicle sensor to presence of the first traffic situation or the second traffic.

The at least one driver assistance system may include at least one of (a) an anti-lock brake system, (b) a ranging warning system, (c) a traction control system, (d) a parking aid system, (e) a lane detection system, (f) a system configured to warn against falling asleep, (g) a lane change assistance system, (h) a stop and go assistance system, (i) a night view system, (j) a road sign detection system, and (k) a pedestrian detection system.

The arrangement may be configured to determine an anticipated time period for the detected traffic situation.

The communications system may include a user interface, which may include: an arrangement configured to restrict, in a restrictive operating mode, a functionality of the radio interface to the wireless communication to the radio communications network; an arrangement configured to display, when there is a call in the restrictive operating mode, an operating mode with restricted functionality to a caller and to make available a plurality of communications functions, at least one communications function selectable by the caller; and an arrangement configured to activate a selected communications function. The arrangement configured to detect the traffic situations may be configured to activate the restrictive operating mode in accordance with a presence of the first traffic situation.

The user interface may be configured to display to the caller at least one of (a) a cause and (b) an anticipated time period for the restrictive operating mode.

The communications system may include a display unit configured to display to a user travel over at least one of (a) the first section and (b) the second section of the route and an anticipated time period for travel.

The communications system may include a memory configured to store information relating to an existing communications link before the first section of a route is reached.

The communications system may include an arrangement configured to restore the communications link after the first section has been travelled through by call of the stored information.

The communications system may include an operator interface configured to receive an input of desired communications links from the user.

The communications system may include an arrangement configured to assign at least one desired communications link input to at least one of the second sections of the route and to output the at least one desired communications link as a communications proposal.

The communications system may include an arrangement configured to establish the desired communications link after acceptance of the communications proposal when a corresponding section section of the route is reached.

In accordance with an example embodiment of the present invention, a method for operating a communications system in a motor vehicle includes: restricting functionality of the communications system during operating as a function of predefined conditions; and offering a plurality of communications functions to a caller for selection when there is an incoming call in the operating mode with restricted functionality.

The method may include performing at least one selected communications function after the selection.

The method may include activating the restrictive operating mode by at least one of (a) a user input and (b) the communications system as a function of a presence of predefined traffic situations.

The method may include detecting the presence of the predefined traffic situations by evaluating data from at least one of (a) a navigation system, (b) a locating system, (c) at least one trial sample vehicle, (d) a digital road map, (e) at least one driver assistance system, and (f) at least one vehicle sensor.

In accordance with an example embodiment of the present invention, a method for operating a communications system in a motor vehicle includes evaluating data as a function of a predefined route to detect at least one of (a) first sections of a route with first traffic situations and (b) second sections of the route with second traffic situations, to define a radio communication on the first sections of the route as incapable of being performed, and to define a radio communication on the second sections of the route as capable of being performed.

The method may include: receiving information input from a user about at least one communications link that is to be maintained during a subsequent journey and that is assigned to at least one of the detected, second sections of the route; and outputting a communications proposal.

The method may include establishing a desired communications link after acceptance of the communications proposal and when a corresponding second section of the route is reached.

The foregoing and further described features are set forth below in the description and appended Figures, it being possible to embody the individual features in each case individually in themselves or as a plurality in the form of subcombinations in one embodiment and in other areas, and to form further embodiments. An exemplary embodiment will be described in more detail below with reference to the appended Figures.

### BRIEF DESCRIPTION OF THE DRAWINGS

FIG. 1 is a block circuit diagram of a communications system for a motor vehicle.

FIG. 2 is a flowchart of a communications method which may be carried out by the system illustrated in FIG. 1.

### DETAILED DESCRIPTION

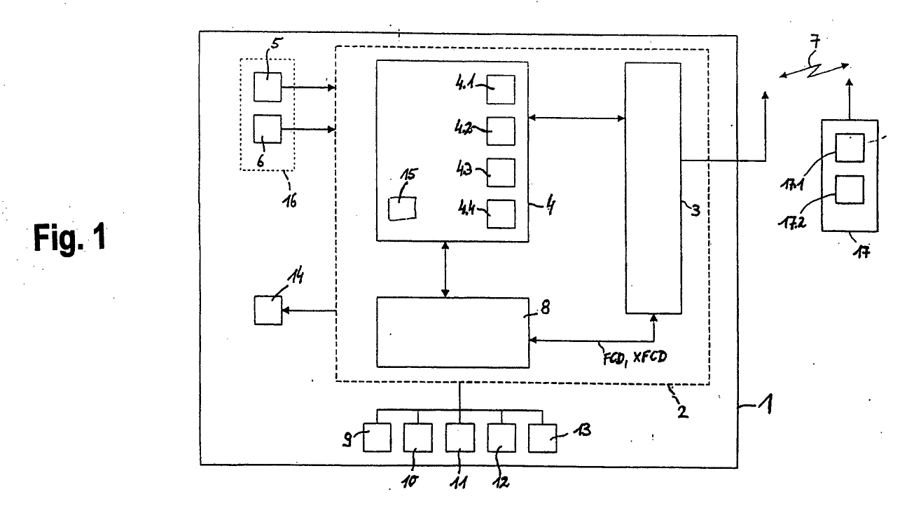

FIG. 1 is a schematic block representation of a motor vehicle 1 with a communications system 2 according to an example embodiment of the present invention. The communications system 2 includes a radio interface 3 for wire-free connection of the communications system 2 to a radio communications network, and for setting up a corresponding communications link 7, a user interface 4 according to an example embodiment of the present invention, and a device for detecting traffic situations 8. In a restrictive operating mode, the user interface 4 restricts a functionality of the radio interface 3 such that a caller may not communicate directly with the user or driver via his terminal 17, for example, a telephone, but rather may communicate with the user interface 4.

In the restrictive operating mode, when there is an incoming call a call signal is suppressed, and a caller is offered a plurality of communications functions 4.1 to 4.4 for selection, it being possible to select in each case at least one communications function 4.1 to 4.4. A first communications function 4.1 cuts off the communications link, a second communications function 4.2 connects the caller to a mailbox, a third communications function 4.3 activates the call signal, and a fourth communications function 4.4 maintains the communications link 7 and activates the call signal after a predefinable time period has expired. One of the communications functions 4.1 to 4.4 is selected by a corresponding input by the caller using the input device 17.2 on his terminal 17.

The communications system 2 is connected to manual activation device 5, to a voice-control system 6 and to a display unit 14 via corresponding electrical connecting lines for communicating with the driver. In order to receive data which is to be evaluated, the communications system 2 is connected, via electrical connecting lines, to a navigation system 9, a locating system 10, a digital map 11, at least one driver assistance system 12 and at least one vehicle sensor 13. In addition, the communications system 2 receives FCD and/or XFCD data from trial sample vehicles via the radio interface 3.

In the illustrated exemplary embodiment, the user interface 4 may be activated by the user by the operator control devices 5, 6, or automatically by the communications system 2, for example as a function of predefinable traffic situations.

In order to activate the user interface 4 automatically, the communications system 2 which is illustrated includes a device 8 for detecting current and future traffic situations which evaluate data from a navigation system 9 and/or from a locating system 10 and/or from trial sample vehicles and/or from a digital road map 11 in order to determine first sections of a route with first traffic situations and/or second sections of a route with second traffic situations, it being defined that a radio communication is incapable of being carried out if one of the first traffic situations is detected, and that a radio communication is capable of being carried out if one of the second traffic situations is detected. The restrictive operating mode of the user interface 4 is activated if one of the first traffic situations is detected. In order to evaluate whether a current traffic situation is one of the first traffic situations or one of the second traffic situations, the device for detecting traffic situations 8 evaluates data from at least one driver assistance system 12 and/or from at least one vehicle sensor 13. By evaluating this data it is possible, for example, to detect driving maneuvers which correspond to a first traffic situation, such as braking phases and acceleration phases, severe steering maneuvers, driving up to a vehicle which is traveling ahead, etc.

The at least one driver assistance system 12 includes, for example, an anti-lock brake system and/or a ranging warning system and/or a traction control system and/or a parking aid system and/or a lane detection system and/or a system for warning about falling asleep at the wheel and/or a lane change assistance system and/or a stop and go assistance system and/or a night view system and/or a road sign detection system and/or a pedestrian detection system, etc.

The device for detecting traffic situations 8 also determines the anticipated time period for the first and second traffic situations. When the user interface 4 is activated by the communications system 2, the reason and the anticipated time period for the operation with restricted functionality is displayed to the caller on his terminal 17 by a corresponding display unit 17.1.

Furthermore, the user or the driver is provided with a display indicating that he is traveling on a first section of a route and/or a second section of a route, and the anticipated time period for traveling on the section, so that when necessary he may set up a communications link.

As an additional functionality, when there is an existing communications link 7 imminent travel over one of the first sections of a route is displayed to the user or driver, and the information relating to an existing communications link 7., for example, the telephone number of the other party to the communication, is stored in a memory 15 in the communications system 2, for example in the user interface 4, before this first section of a route is reached.

After the first section of a route has been travelled through, the communications link 7 is restored by calling the stored information, the calling of the information being carried out by the operator control devices 5, 6.

In addition, or as an alternative, the user may use the illustrated communications system 2 to plan his own calls. For this purpose, the user enters, for example, before he starts a journey, his destination and the desired communications links which are to be set up during the journey, and an anticipated call duration by the operator interface 16 which contains the manual activation device 5 and the voice-control system 6.

The communications system 2 determines, as a function of a destination which is input and the calculated route, first sections of a route on which the radio interface 3 is to be operated with a restricted functionality due to the traffic situations which are present there, and/or second sections of a route on which normal operation of the radio interface 3 is possible due to the traffic situations which are present there. In an example embodiment of the present invention, the first and/or second sections of a route which are determined are displayed to the user. The communications system 2 assigns at least one of the desired communications links 7 which have been input to at least one of the specific second sections of a route, and outputs this assignment as a communications proposal to the user via the display 14 which may be embodied, for example, as a screen, as a voice output system, etc.

If the user accepts the communications proposal, the communications system 2 then stores the information about the respectively desired communications link and the assigned, second section of a route. In addition, the device for detecting traffic situations 8 continuously carries out an evaluation of the current traffic situation in which it is detected whether the current traffic situation corresponds to one of the first or one of the second traffic situations. If, when the assigned second section of a route is reached, the current traffic situation corresponds to one of the second traffic situations, the desired communications link 7 is set up by the communications system 2 using the stored information. Alternatively, it is possible that it is only indicated to the user that he may now set up the desired communications link 7.

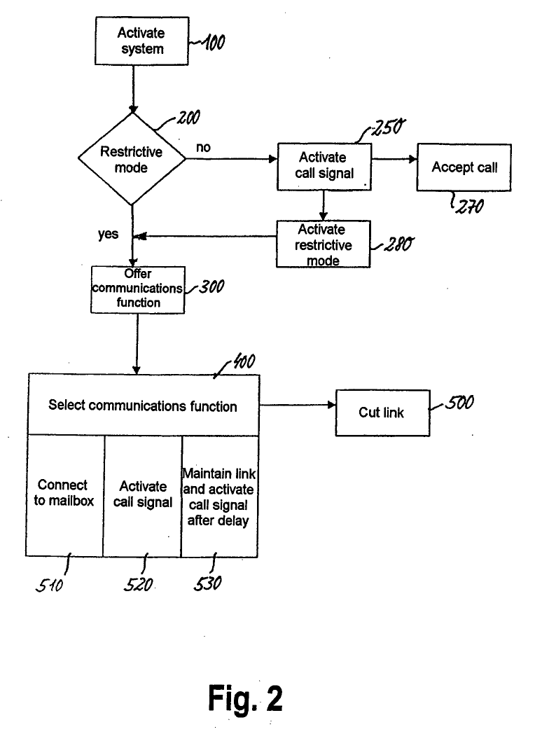

FIG. 2 shows a flowchart for an operating method of the communications system 2 illustrated in FIG. 1 in which the functionality of the radio interface 3 may be restricted by a restrictive operating mode as a function of predefined conditions. When there is an incoming call, i.e., when a communications link 7 has been set up, the communications system 2 is activated in step 100. In step 200 it is tested whether the communications system 2 is being operated in the restrictive operating mode, i.e., whether or not the user interface 6 is activated, it being possible for the restrictive operating mode of the user interface 4 to be activated by the communications system 2 or by the user, as described above. If the restrictive operating mode is not activated, the call signal is activated in step 250, and the user may accept the call in step 270 or activate the restrictive operating mode of the user interface 4 using the operator control devices 5, 6 in step 280, in order to signal that the user does not wish to accept the call immediately but rather in a short time. In the restrictive operating mode, a plurality of communications functions 4.1 to 4.4 are made available to the caller in step 300. In step 400, the caller selects one of the available communications functions 4.1 to 4.4, for example, by inputting a number on his terminal 17 or by a speech input.

When a first communications function 4.1 is selected, the communications link is cut in step 500. This communications function 4.1 is also triggered by placing the device in the on hook state. Subsequently, the communications system 2 returns to its initial state until a new call is received.

When a second communications function 4.2 is selected, the caller is connected to a mailbox in step 510.

When a third communications function 4.3 is selected, the call signal is activated in step 520.

When a fourth communications function 4.4 is selected, in step 530 the communications link is maintained and the call signal is activated after a specific time period has expired. The time period may be determined by the device for detecting traffic situations 8, and may correspond to the anticipated time period until the current traffic situation ends or the current first section of the route has been travelled through. If the restrictive operating mode has been activated by the user using the operator control devices 5, 6, the specific time period may be a permanently predefined time interval, for example, 20 seconds. As an alternative to displaying the time period until the call has been put through, it is possible to indicate to the caller that the user will accept the call in a short time.

In an example embodiment of the user interface, a rejected call, i.e., a call which was not accepted, is signalled in the display unit 14. This is the case, for example, if the caller selects the communications functions 4.1 or 4.2 described above. This display may be a generally understandable symbol or a complete text with name and telephone number of the caller. Analogously, it is possible to place an indication of a message in the mailbox on the display unit.

The user may then use the operator control devices 5, 6 to set up, for example, a radio communication with the caller whose call was rejected, or set up, for example, a radio communication with his mailbox.

In an example embodiment of the user interface, in a manner which is analogous to the rejected calls, short messages (SMS) and/or electronic messages (email), for example, are also displayed on the display unit 14. Such a display may be issued only when the vehicle is in a stationary state in order to avoid distracting the user excessively from his actual task.

What is claimed is:

1. A user interface for a communications system in a motor vehicle, comprising:
an arrangement configured to restrict, in a restrictive operating mode, a functionality of a radio interface to a wireless communication to a radio communications network;
an arrangement configured to display, when there is a call in the restrictive operating mode, the restrictive operating mode to a caller and to make available a plurality of communications functions, at least one communications function selectable by the caller; and
an arrangement configured to activate a selected communications function.

2. The user interface according to claim 1, further comprising an arrangement configured to activate the restrictive operating mode in accordance with a user input and an activation instruction issued by a vehicle-mounted device.

3. The user interface according to claim 2, further comprising at least one of (a) a manual activation device and (b) a voice-control system, the at least one of (a) the manual activation device and (b) the voice-control system configured to receive the user input.

4. The user interface according to claim 1, wherein the user interface is configured to suppress a call signal in the restrictive operating mode.

5. The user interface according to claim 1, wherein one of the communications functions includes cutting a communications link.

6. The user interface according to claim 1, wherein one of the communications functions includes connecting the caller to a mailbox.

7. The user interface according to claim 1, wherein one of the communications functions includes activating a call signal.

8. The user interface according to claim 1, wherein one of the communications functions includes maintaining a communications link and activating a call signal after a determinable time period has expired.

9. The user interface according to claim 1, wherein a first one of the communications functions includes cutting a communications link, a second one of the communications functions includes connecting the caller to a mailbox, a third one of the communications functions includes activating a call signal, and a fourth one of the communications functions includes maintaining a communications link and activating a call signal after a determinable time period has expired.

10. A communications system for a motor vehicle, comprising:
a radio interface configured to wirelessly connect to a radio communications network and to establish a corresponding communications link; and
an arrangement configured to detect at least one of (a) a first traffic situation and (b) a second traffic situation, to define a radio communication as incapable of being performed in accordance with a detection of the first traffic situation, and to define the radio communication as capable of being performed in accordance with a detection of the second traffic situation.

11. The communications system according to claim 10, wherein the arrangement is configured to evaluate, as a function of a predefinable route, data from at least one of (a) a navigation system, (b) a locating system, (c) at least one trial sample vehicle, and (d) a digital road map to determine at least one of (a) first sections of a route with first traffic situations and (b) second sections of a route with second traffic situations.

12. The communications system according to claim 10, wherein the arrangement is configured to evaluate a current traffic situation as a function of date from at least one of (a) at least one driver assistance system and (b) at least one vehicle sensor to presence of the first traffic situation or the second traffic.

13. The communications system according to claim 12, wherein the at least one driver assistance system includes at least one of (a) an anti-lock brake system, (b) a ranging warning system, (c) a traction control system, (d) a parking aid system, (e) a lane detection system, (f) a system configured to warn against falling asleep, (g) a lane change assistance system, (h) a stop and go assistance system, (i) a night view system, (j) a road sign detection system, and (k) a pedestrian detection system.

14. The communications system according to claim 10, wherein the arrangement is configured to determine an anticipated time period for the detected traffic situation.

15. The communications system according to claim 10, further comprising a user interface including:
an arrangement configured to restrict, in a restrictive operating mode, a functionality of the radio interface to the wireless communication to the radio communications network;
an arrangement configured to display, when there is a call in the restrictive operating mode, an operating mode with restricted functionality to a caller and to make available a plurality of communications functions, at least one communications function selectable by the caller; and
an arrangement configured to activate a selected communications function;
the arrangement configured to detect the traffic situations configured to activate the restrictive operating mode in accordance with a presence of the first traffic situation.

16. The communications system according to claim 15, wherein the user interface is configured to display to the caller at least one of (a) a cause and (b) an anticipated time period for the restrictive operating mode.

17. The communications system according to claim 11, further comprising a display unit configured to display to a user travel over at least one of (a) the first section and (b) the second section of the route and an anticipated time period for travel.

18. The communications system according to claim 17, further comprising a memory configured to store information relating to an existing communications link before the first section of a route is reached.

19. The communications system according to claim 18, further comprising an arrangement configured to restore the communications link after the first section has been travelled through by call of the stored information.

20. The communications system according to claim 10, further comprising an operator interface configured to receive an input of desired communications links from the user.

21. The communications system according to claim 20, further comprising an arrangement configured to assign at least one desired communications link input to at least one of the second sections of the route and to output the at least one desired communications link as a communications proposal.

22. The communications system according to claim 21, further comprising an arrangement configured to establish the desired communications link after acceptance of the communications proposal when a corresponding section of the route is reached.

23. A method for operating a communications system in a motor vehicle, comprising:
restricting functionality of the communications system during operating as a function of predefined conditions; and
offering a plurality of communications functions to a caller for selection when there is an incoming call in the operating mode with restricted functionality.

24. The method according to claim 23, further comprising performing at least one selected communications function after the selection.

25. The method according to claim 23, further comprising activating the restrictive operating mode by at least one of (a) a user input and (b) the communications system as a function of a presence of predefined traffic situations.

26. The method according to claim 25, further comprising detecting the presence of the predefined traffic situations by evaluating data from at least one of (a) a navigation system, (b) a locating system, (c) at least one trial sample vehicle, (d) a digital road map, (e) at least one driver assistance system, and (f) at least one vehicle sensor.

27. A method for operating a communications system in a motor vehicle, comprising:
evaluating data as a function of a predefined route to detect at least one of (a) first sections of a route with first traffic situations and (b) second sections of the route with second traffic situations, to define a radio communication on the first sections of the route as incapable of being performed, and to define a radio communication on the second sections of the route as capable of being performed.

28. The method according to claim 27, further comprising:
receiving information input from a user about at least one communications link that is to be maintained during a subsequent journey and that is assigned to at least one of the detected, second sections of the route; and
outputting a communications proposal.

29. The method according to claim 28, further comprising establishing a desired communications link after acceptance of the communications proposal and when a corresponding second section of the route is reached.
